(19) United States
(12) Patent Application Publication
(10) Pub. No.: US 2017/0366528 A1
(43) Pub. Date: Dec. 21, 2017

(54) SECONDARY SECURE COMMUNICATION CHANNLES

(71) Applicant: Lior Malka, San Jose, CA (US)

(72) Inventor: Lior Malka, San Jose, CA (US)

(21) Appl. No.: 15/186,430

(22) Filed: Jun. 18, 2016

(51) Int. Cl. H04L 29/06

(52) U.S. Cl. CPC H04L 63/08; H04L 65/1069; H04L 63/10; H04L 2209/72

(57) ABSTRACT

Embodiments are provided for establishing secondary secure channels in any network, including networks that enforce a single channel per neighbor policy. In one embodiment, requests to open a new channel are handled only in a listen mode and identifiers are used to authenticate the first and second secure channels. The channels provide secure communication. In one embodiment, a second channel is provisioned using the primary secure channel. In one embodiment, a method of storing data for provisioning secondary secure channels is provided.

### BACKGROUND

In the vast majority of networks, there is no difference between the first channel established between two parties and subsequent channels. All channels are handled in the same way. Also, each party is in an always listen mode, where requests to open a new channel are always accepted. In contrast, networks with a single channel per neighbor only allow one channel, and may also enter a no listen mode after the channel has been established. These networks have stronger correctness and reliability guarantees, but at the price of limiting usability and applicability.

### SUMMARY

Embodiments are provided for establishing secondary secure channels in any network, including networks that enforce a single channel per neighbor policy. In one embodiment, switching between a no listen mode and a listen mode determines whether requests to open a new channel are ignored or handled, respectively, and when a channel is established, a first or a second secure channel is authenticated, depending on whether the party associated with the channel is already connected. After authentication, the channels may be used for secure communication. Any authentication method may be used. In one embodiment, a second secure channel is provisioned using the first secure channel. Any method for establishing the first secure channel may be used. In one embodiment, a method of storing data for provisioning secondary secure channels is provided.

### DRAWINGS

The following figures illustrate the embodiments by way of example. They do not limit their scope.

FIG. 1 shows a flow diagram of a method of establishing a primary and a secondary secure channel, in accordance with one embodiment.

FIG. 2 shows a flow diagram of a method of provisioning a secondary secure channel, in accordance with one embodiment.

FIG. 3 shows a flow diagram of a method of storing data for provisioning secondary secure channels, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

Communication involves a plurality of parties. The set of parties that communicate with a party is the neighbors of that party. Parties may have a unique identifier and may be in different or identical locations. Parties communicate via a channel which may be closed in any way. Each pair of parties may or may not have a unique channel, and elements used to establish a channel in one direction may or may not be used to establish a channel in the reverse direction. Data sent on the channel may or may not arrive, may or may not be delayed, and may or may not be corrupted.

A party is in listening mode if it accepts requests to open a new channel. Otherwise, it is in a no listen mode. A listening policy selects a listening mode. For example, in a single channel per neighbor policy, a party listens until a channel has been established with each of its neighbors, and then switches back to a no listen mode, resuming listening only if a channel with one of the neighbors drops. A single channel per neighbor policy can be adapted to temporarily switch to a listen mode so that a neighbor that is already connected can establish a secondary channel. Such a policy is called single channel with temporary windows. Another listening policy that supports secondary channels is the always listen policy.

In cryptography, encryption provides data confidentiality, signatures provide data integrity, and signcryption provides both. A secure channel provides data confidentiality, data integrity, and authenticity. Elements such as identifiers, tokens, and cryptographic functions such as signcryption may be used to establish a secure channel. For example, an identifier followed by the output of a cryptographic function applied to a token may be used to establish a secure channel. Elements can be serialized. Serialization involves the formatting of data so that it can be transmitted or stored. For example, an identifier and a construct containing a token and a cryptographic function may be sent from one party to another.

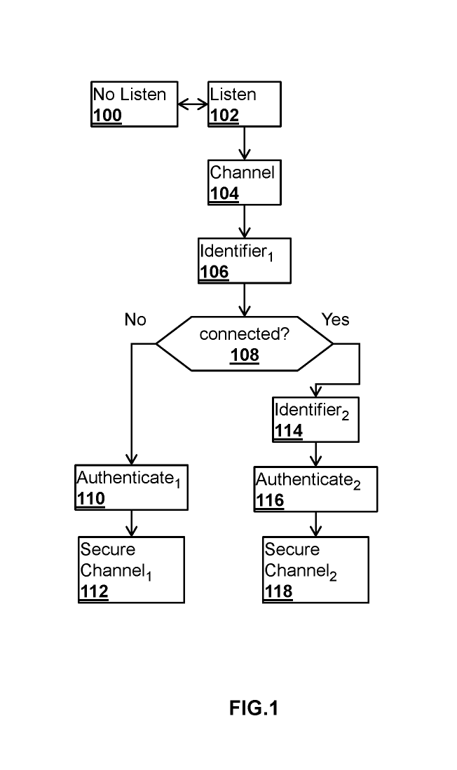

FIG. 1 shows a flow diagram of a method of establishing a primary and a secondary secure channel, in accordance with one embodiment. Requests to open a channel are ignored in a no listen 100 mode and accepted in listen 102 mode. Any listening policy that supports secondary channels may be used. When a request to open a channel is accepted, a channel 104 is established. A first identifier 106 is read from the channel, and the channel is closed if the first identifier is invalid. If the party associated with the first identifier is not connected 108, then a first authentication 110 is applied to the channel. If the first authentication is successful, then a first secure channel 112 is outputted, and one of the listening modes is resumed. Otherwise, the channel is closed. If the party associated with the first identifier is connected, then a second identifier 114 is read from the channel, and the channel is closed if the second identifier is invalid. Otherwise, a second authentication 116 is applied to the channel, and if successful, then a second secure channel 118 is outputted. Otherwise, the channel is closed. The first and second secure channels may be used for secure communication.

Any method can be used for the first and second identifiers, and the methods may be identical or not. The first and second identifiers may be validated in any way. For example, they can be validated using a list, a database, a predicate, and so on. The first and second authentication can use any method, and the methods may be identical or not. For example, a signcryption function corresponding to the identifier may be applied to the channel so that a token can be read, and authentication is successful if the token is valid.

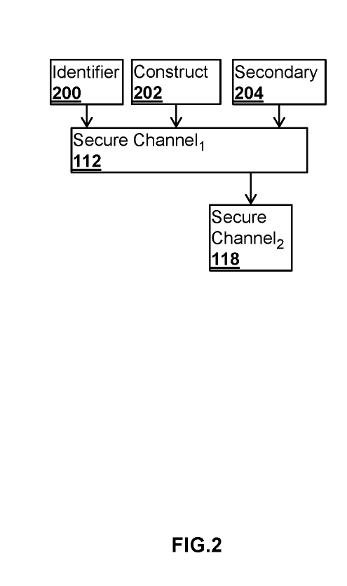

FIG. 2 shows a flow diagram of a method of provisioning a secondary secure channel, in accordance with one embodiment. A first party sends a secondary message 204 to a second party over a first secure channel 112. Any method may be used to establish the first secure channel. Using randomness, the second party generates an identifier 200 and a construct 202 for establishing a secure channel. The identifier and the construct are sent over the secure channel to the first party.

Depending on the listening policy, the second party may also temporarily switch into listening mode so that requests to open a new channel are accepted. The first party uses the identifier and the construct to establish a second secure channel 118 with the second party. The second secure channel may be used for secure communication.

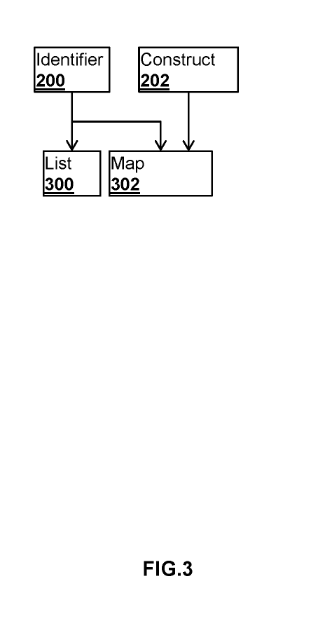

FIG. 3 shows a flow diagram of a method of storing data for provisioning secondary secure channels, in accordance with one embodiment. The data for provisioning a secondary secure channel includes an identifier 200 and a construct 202. A list 300 and a map 302 provide operations on the data, such as insert, remove, and so on. An insert operation adds the identifier to the list, and maps it to the construct in the map. A remove operation removes the identifier from the list, removes the identifier and the construct from the map, and returns the construct.

The identifier and the corresponding construct may be removed for any reason, such as when the identifier is used for establishing a secondary secure channel. Alternatively, the number of identifiers may be limited by a threshold. Moreover, if the threshold is reached, then the oldest element inserted can be removed so that room is made. The list may be used to find the oldest element inserted.

The method can be used by any party. For example, a second party provisioning a secondary channel to a first party may use the method.

The specific embodiments and specific terminology used above should not be construed as limiting the scope of the embodiments. These details have been presented for purposes of illustration and are not intended to be exhaustive. Many modifications and uses are possible. The scope of the embodiments is defined by the Claims appended hereto and their equivalents.

What is claimed is:

1. A method of establishing a primary and a secondary secure channel, the method comprising:
switching between a listen and a no listen mode; and
obtaining a channel when a request to open a channel arrives in listen mode; and
reading a first identifier from the channel; and
using a first authentication to output a first secure channel if the party associated with the first identifier is not connected; and
reading a second identifier and using a second authentication to output a second secure channel if the party associated with the first identifier is connected.

2. The Method of claim 1, wherein the listening policy is a single channel with temporary windows.

3. The Method of claim 1, wherein the first secure channel is used for provisioning a secondary secure channel.

4. The Method of claim 1, wherein the second secure channel is used for general purpose services.

5. The Method of claim 1, wherein the same services are provided on the first and the second channels.

6. The Method of claim 1, wherein authenticating the channel if the identifier is valid is done by obtaining from a database or memory a cryptographic function corresponding to the identifier.

7. The Method of claim 1, further comprising incrementing a counter associated with the first identifier if the identifier is valid.

8. The Method of claim 1, wherein the second identifier is stored in a memory and is removed from memory after being read from the channel.

9. A method of provisioning a secondary secure channel, the method comprising:
sending over a first secure channel a secondary message from first party to a second party; and
generating using random values an identifier and a construct containing elements used to establish the second secure channel; and
sending the identifier and the construct over the first secure channel from the second party to the first party; and
outputting a secure channel established using the identifier and the construct.

10. The method of claim 9, wherein the construct contains a token, and a sequence representing a signcryption.

11. The method of claim 9, further comprising storing in memory the identifier and the construct and removing them from memory when used for establishing a second secure channel.

12. The method of claim 9, further comprising temporarily switching to a listen mode for a fixed amount of time.

13. A method of storing data for provisioning secondary secure channels, the method comprising:
receiving an identifier and a construct for establishing a secondary secure channel; and
mapping the identifier to the construct.

14. The Method of claim 13, further comprising removing the mapping if the identifier is read during establishment of a secure channel.

15. The Method of claim 13, further comprising removing the first inserted identifier and corresponding construct before additional insertion if the number of identifiers is above a threshold.

16. The Method of claim 13, wherein the mapping is stored in memory.

17. The Method of claim 13, wherein each neighbor has a dedicated mapping.

18. The Method of claim 13, wherein the mapping is removed if the party associated with the identifier is no longer a neighbor.
